(19) United States
(12) Patent Application Publication
(10) Pub. No.: US 2009/0284035 A1
(43) Pub. Date: Nov. 19, 2009

(54) INTERCHANGEABLE BUILT-IN UNIT FOR VEHICLES

(75) Inventor: Burkhard RUTHER, Anrochte (DE)

Correspondence Address: NORRIS, MCLAUGHLIN & MARCUS, 875 THIRD AVE, 18TH FLOOR, NEW YORK, NY, 10022, US

(73) Assignees: Burkhard Ruther, Anrochte (DE); Reiner Ising, Ruthen (DE)

(21) Appl. No.: 12/467,815

(22) Filed: May 18, 2009

(30) Foreign Application Priority Data
May 19, 2008 (DE) 102008024169.5

(51) Int. Cl. B60P 3/42

(52) U.S. Cl. 296/24.33

(57) ABSTRACT

An interchangeable built-in unit for vehicle upper bodies, e.g. containers, or vehicles, in particular motor vehicles (30), such as station wagons, delivery vans, minibuses, but also trailers with enclosed upper bodies and similar vehicles, including the interchangeable built-in unit suitable for installation and removal on a floor of the vehicle upper body or of the vehicle, the interchangeable built-in unit has a base plate which can be at least indirectly placed on the floor, and the interchangeable built-in unit has fastening means for attaching the base plate at least indirectly on the floor.

### BACKGROUND OF THE INVENTION

(1) Field of the Invention

The present invention relates to an interchangeable built-in unit for vehicle upper bodies, for example containers or other interchangeable receptacles, or vehicles, in particular motor vehicles, such as station wagons, delivery vans, minibuses and trailers with enclosed upper bodies and similar vehicles.

Motor vehicles, such as station wagons, delivery vans, minibuses, but also so-called minivans, are frequently used as business vehicles in trade businesses. The vehicles are frequently equipped with built-in shelves, built-in cabinets and the like, where the craftsmen store materials and tools. It is also known to fixedly install electrical devices, for example measurement instruments, in shelves or in cabinets in an interior space of a vehicle.

(2) Description of Related Art

These commercial vehicles are typically only used during weekdays. The vehicles remained unused on weekends and on off-days. This is due to the fixed built-in units in the vehicles, which make it impossible or difficult to use the vehicles differently on off-days. Such other use of the vehicles on off-days could include, for example, the use of the vehicles for transporting passengers or as a camper.

In addition, the fixed built-in units in the interior space of the vehicle can also present obstacles during working hours. The built-in units are a hindrance particularly when larger-sized goods are to be transported which occupy the entire or almost the entire interior space of the vehicle.

Private persons can also encounter similar problems. For example, a private person likes to use a minivan in everyday use for transporting passengers while desiring to use the vehicle during a vacation as a recreational vehicle (RV).

The aforementioned problems can not only occur with motor vehicles, but also with trailers having enclosed upper bodies, containers or other interchangeable receptacles.

Many users of such a vehicle upper bodies or vehicles desire to use their vehicle upper bodies or vehicles more flexibly. This is the basis for the present invention.

### BRIEF SUMMARY OF THE INVENTION

It is an object of the present invention to make it possible to use vehicles upper bodies or vehicles more flexibly.

The subject is attained by an interchangeable built-in unit for vehicle upper bodies or vehicles according to the invention. Such interchangeable built-in unit according to the invention can be installed in or removed from the vehicle upper bodies or vehicles. The interchangeable built-in unit can be removed from the vehicle upper body or the vehicle depending on the desired use. The interchangeable built-in unit is suitable and configured for installation on and removal from a floor of the vehicle upper body or of the vehicle. The interchangeable built-in unit has a base plate which can be at least indirectly placed on the floor. The interchangeable built-in unit has fastening means by which the base plate can be at least indirectly attached on the floor. Such interchangeable built-in unit according to the invention can be quickly removed from the vehicle upper body or the vehicle and exchanged for another interchangeable built-in unit according to the invention. In this way, the vehicle can be used in different ways simply by exchanging the interchangeable built-in units. The vehicle upper body or the vehicle can then be used for different purposes with significantly greater flexibility.

An interchangeable built-in unit may include furniture items attached on the base plate. Preferably, the furniture items are releasably attached on the base plate. Alternatively, the attachment location of the furniture items on the base plate may be changeable. More particularly, the furniture items may be moved and/or rotated on the base plate.

The furniture items of an interchangeable built-in unit according to the invention may include benches, individual seats, shells, cabinets and/or tables. Electrical or mechanical devices may be installed in the shells or cabinets.

Lashing eyelets, focus and the like, with which the goods to be transported can be attached on the base plate, may be attached on a top side of the base plate.

The interchangeable built-in unit according to the invention may include rollers, rails, sliders and the like disposed on a bottom side of the base plate. These rollers, rails, sliders and the like can be used to at least indirectly move the interchangeable built-in unit on the floor.

A foldable or collapsible undercarriage may be arranged on the bottom side of the base plate. This undercarriage may be folded up or flipped open when the interchangeable built-in unit is removed from the vehicle or the vehicle upper body, so that the interchangeable built-in unit can be moved on the undercarriage outside the vehicle upper body or the vehicle. Alternatively, an optionally height-adjustable table trolley or a stand can be used to support the interchangeable built-in unit outside the vehicle or the vehicle upper body.

The interchangeable built-in unit may include eyelets, hooks and the like configured for attachment to a lifting gear. The interchangeable built-in unit can be suspended with the lifting gear from a crane.

The bottom side of the base plate of an interchangeable built-in unit according to the invention may include regions suitable and configured for engagement with a lifting fork of a lifting van or a forklift.

The base plate may be composed of several parts. The parts of the base plate may be interconnected by braces, in particular hinges. Parts of the base plate can then be temporarily separated or flipped over with respect to the rest of the base plate, thereby enabling a simple installation or removal of the base plate in/from the vehicle or the vehicle upper body. This is advantageous, for example, if the contour of the interior space of the vehicle has recesses, for example due to wheel housings.

The object according to the invention is also attained with an arrangement of a vehicle upper body or a vehicle and an interchangeable built-in unit according to the invention. The interchangeable built-in unit is here at least indirectly removably installed on a floor of the interior space of the vehicle upper body or the vehicle.

A connecting plate may be installed on the floor of the interior space of an arrangement according to the invention. The interchangeable built-in unit may be removably mounted on the connecting plate.

With an arrangement according to the invention, fastening means for attaching the connecting plate on the floor or for removably mounting the base plate of the interchangeable built-in unit may also be provided on the floor of the interior space. The fastening means may include hooks, eyelets, bores, threaded rods or threaded bolts, and the like.

Rollers, rails, sliders, grooves, holes, fastening elements and the like, on which the base plate can move, may be mounted on the floor of the interior space or on the connecting plate. The connecting plates may be omitted if such elements are provided on the floor of the interior space of the vehicle and the vehicle upper body, respectively.

The vehicle upper body or the vehicle of an arrangement according to the invention may include a door, a gate and the like, by which the disassembled interchangeable built-in unit can be removed from the vehicle upper body or the vehicle.

Exemplary embodiments of the interchangeable built-in units according to the invention and arrangements of vehicles and interchangeable built-in units according to the invention will now be described in more detail with reference to the drawings.

### BRIEF DESCRIPTION OF THE SEVERAL VIEWS OF THE DRAWING(S)

FIG. 1 to FIG. 5 show diagrams of a base plate of interchangeable built-in unit according to the invention,

FIG. 6 to FIG. 9 show diagrams of a base plate with folding undercarriage,

FIG. 10 to FIG. 13 show diagrams of an arrangement of a delivery van and a base plate according to FIG. 1,

FIG. 14 to FIG. 17 shoal diagrams of an arrangement of a delivery van and a base plate according to FIG. 6,

FIG. 18 to FIG. 21 show diagrams of the arrangement according to FIG. 14 with a recreational vehicle (RV) unit on the base plate,

FIG. 22 to FIG. 25 of the arrangement according to FIG. 14 with a shelf system on the base plate, and

FIG. 26 to FIG. 29 show diagrams of an arrangement according to FIG. 14 with benches on the base plate.

### DETAILED DESCRIPTION OF THE INVENTION

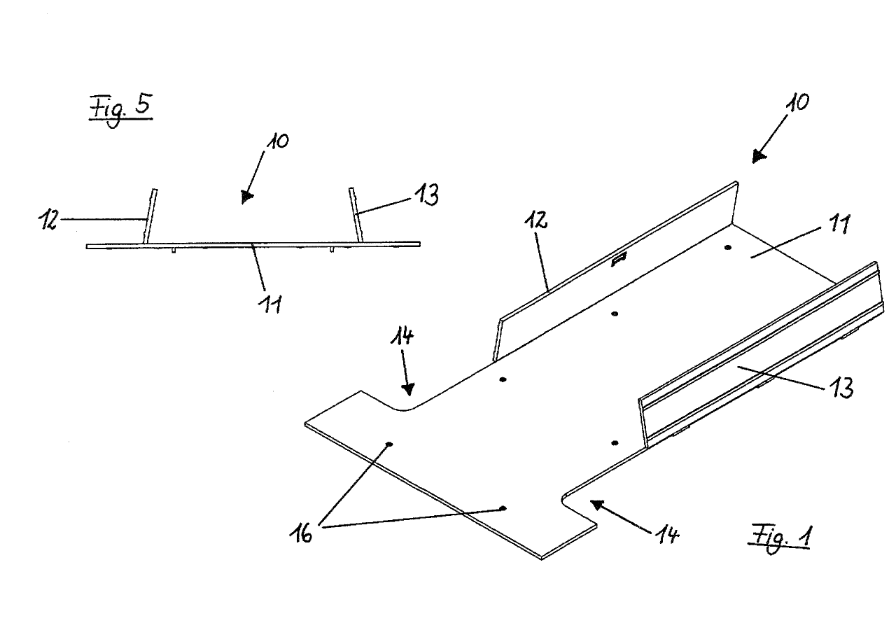

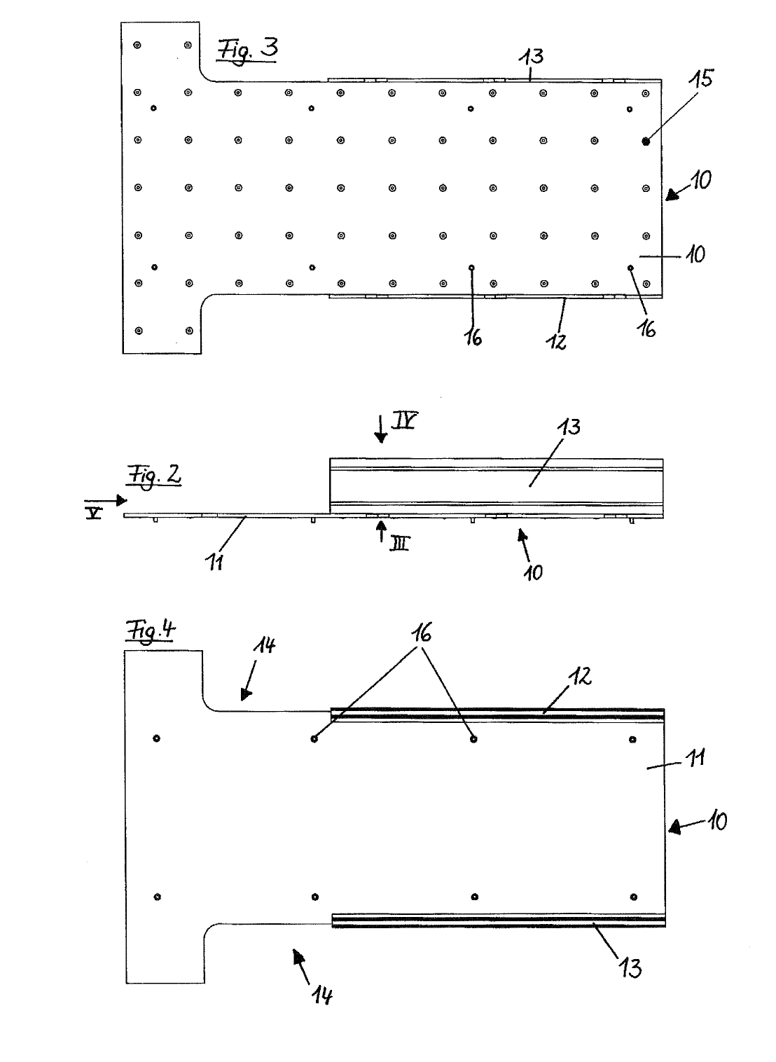

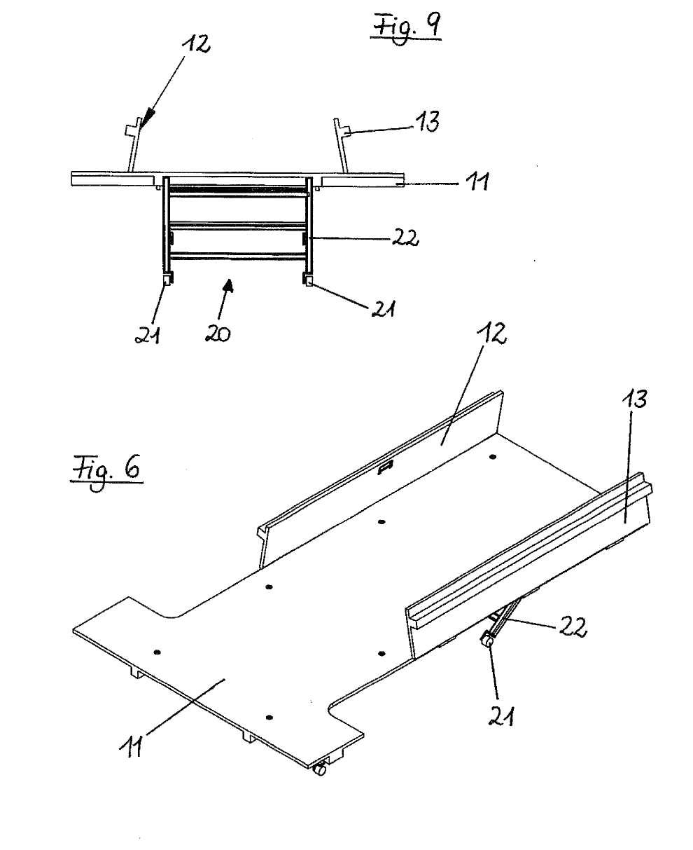

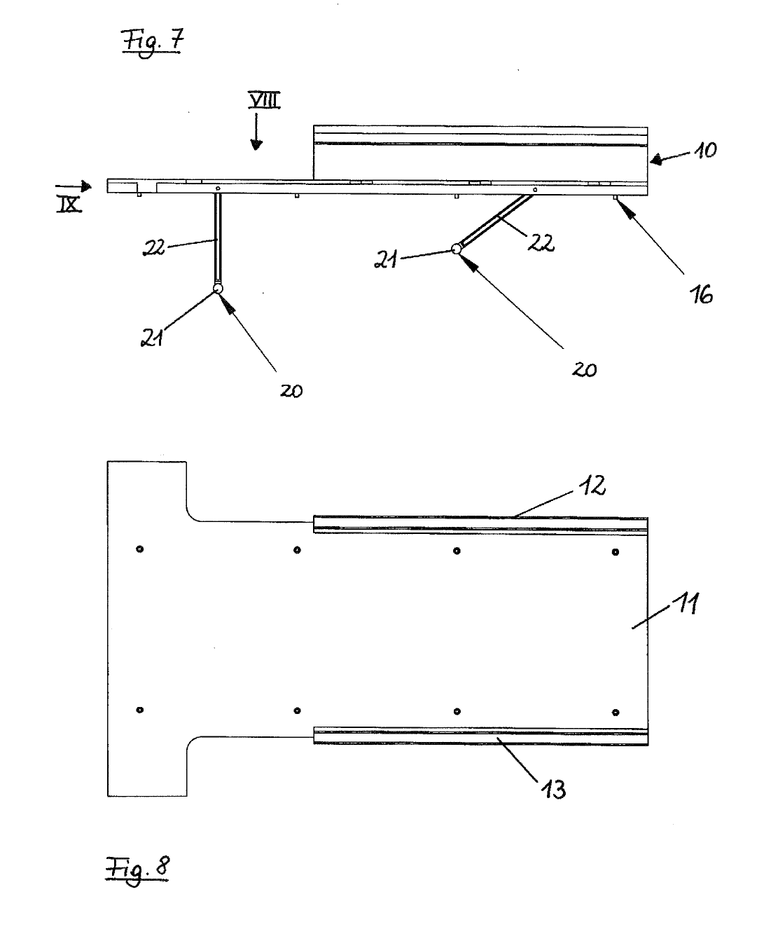

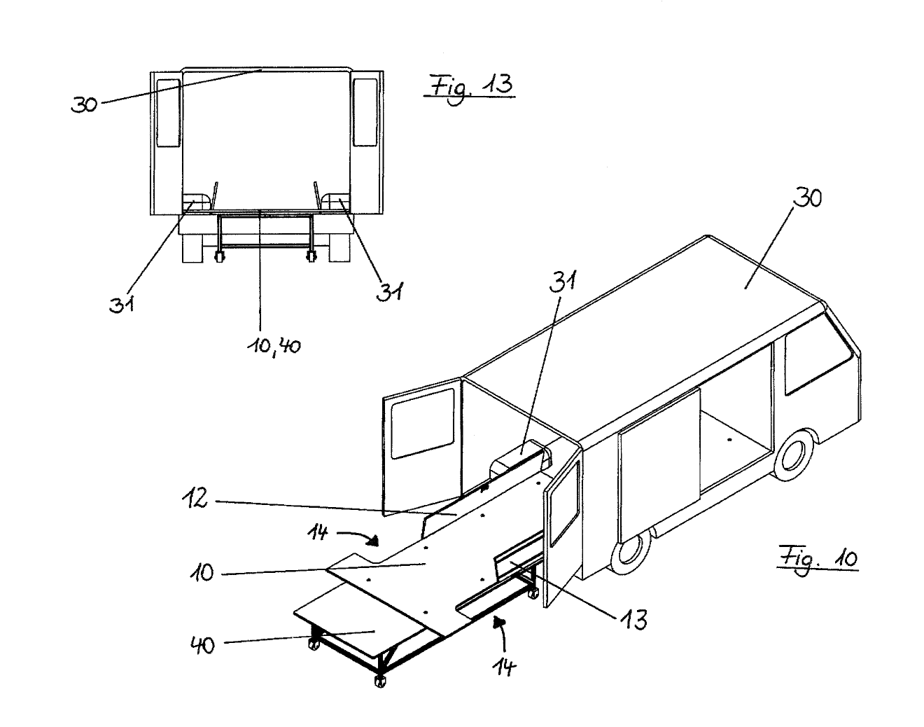

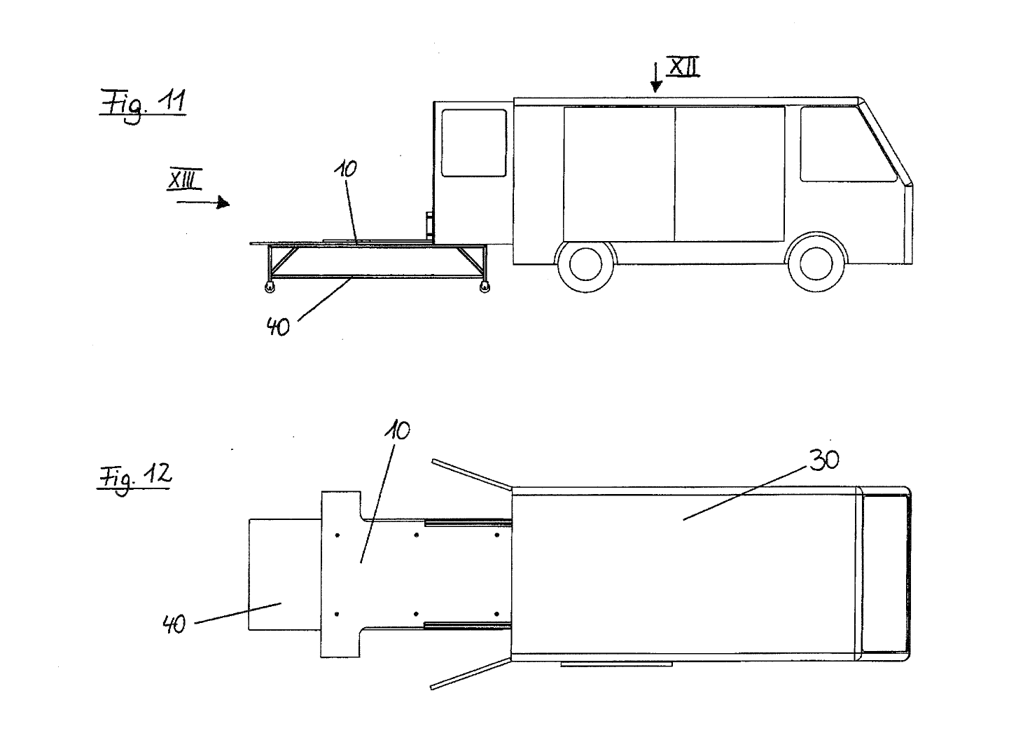

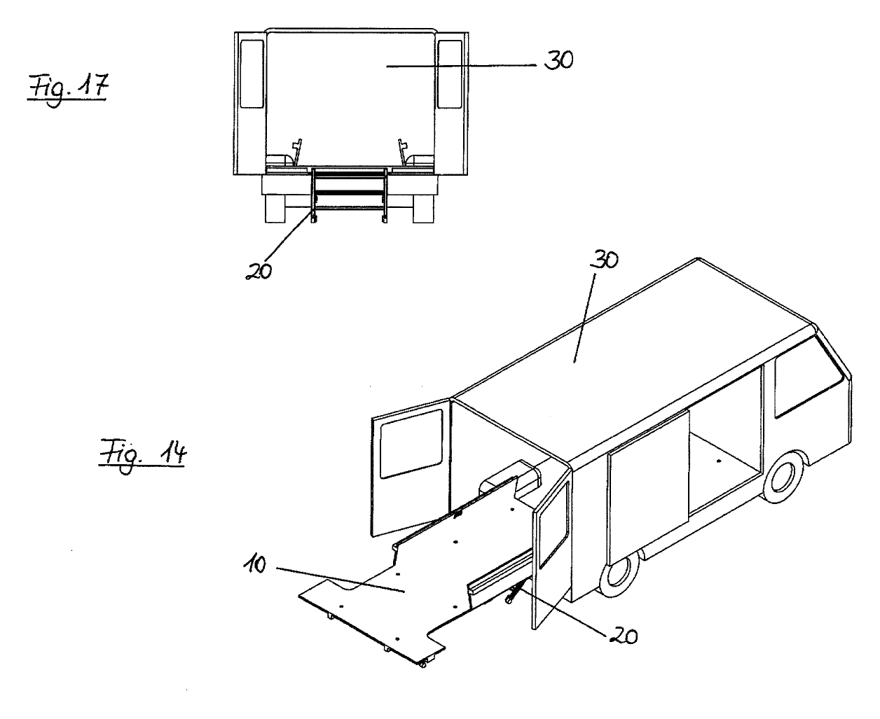

The base plate 10 of an interchangeable built-in unit according to the invention illustrated in FIGS. 1 to 5 has an outside contour which is shaped to match the contour of the floor in the interior of a delivery van. The outside contour of the base plate 10 is essentially rectangular. The base plate 10 is composed of three parts 11, 12, 13. The first part 11 of the three parts 11, 12, 13 is connected via hinges with a second and a third of the three parts 11, 12, 13. In FIGS. 1 to 5, the second part 12 and the third part 13 of folded up with respect to the first part 11. In a folded-down position, the top sides of the three parts 11, 12, 13 of the base plate form a plane. The base plate then has the already described essentially rectangular contour. The rectangular contour of the base plate 10 is only interrupted by two recesses 14. These two recesses 14, which are located adjacent to the second part 12 and the third part 13, are configured to receive wheel housings which protrude into the interior space of the vehicle in which the base plate 10 can be installed.

Rollers 15 are attached on the bottom side of the base plate 10 and can be used to roll the base plate 10 along the floor of the interior space of the vehicle. In addition, fastening elements 16 are provided on the base plate 10, which can be operated from the top side of the base plate 10 and used to fixedly connect the base plate 10 with the floor of the interior space of the vehicle.

The interchangeable built-in unit illustrated in FIGS. 6 to 9 includes in addition to the base plate 10 a foldable undercarriage 20 which is attached to the bottom side of the base plate 10. The base plate is configured essentially like the base plate illustrated in FIGS. 1 to 5. However, unlike the base plate 10 of FIGS. 1 to 5, the base plate 10 of the interchangeable built-in unit illustrated in FIGS. 6 to 9 does not include rollers 15 on the bottom side.

The foldable undercarriage 20 includes two frames 22 which are pivotally attached on the bottom side of the base plate 10. Rollers 21 are provided at the bottom ends of the undercarriage 20 when the undercarriage 20 is unfolded.

In the installed position of the interchangeable built-in unit, the undercarriage 20 is retracted. It is then located between the bottom side of the base plate 10 and the floor of the vehicle. However, when the interchangeable built-in unit is removed from the vehicle, the parts of the undercarriage 20 are sequentially folded out and the interchangeable built-in unit rests on the undercarriage 20. The interchangeable built-in unit can then be moved on the undercarriage 20.

The arrangement is depicted in FIGS. 10 to 13 includes in addition to the interchangeable built-in unit, which includes the base plate 10, a vehicle 30 in which the interchangeable built-in unit, i.e., the base plate 10, is installed or removed from. The base plate 10 rests partially on a rolling table 40 which has the height of the floor of vehicle 30. The base plate can hence be effortless inserted in the interior space of the vehicle 30 from the rolling table 40, or vice versa, moved out of the interior space of the vehicles 30 onto the rolling table 40. The wheel housings 31 of the rear wheels of the vehicle project into the interior space of the motor vehicle 30. To facilitate insertion of the base plate 10 into the interior space of the vehicle 30 without requiring a significant force, the second and the third part 12, 13 of the base plate are folded up. When the base plate 10 is fully inserted into the vehicle, the second part 12 and the third part 13 can be folded down, causing the wheel housings 31 to engage in the recesses 14 of the base plate.

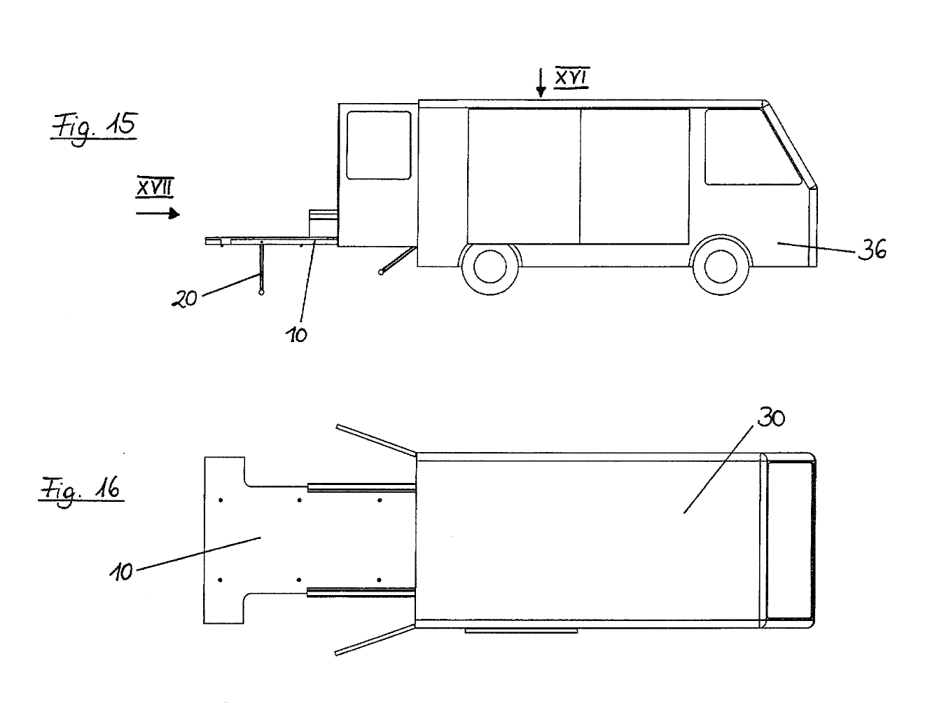

The arrangement illustrated in FIGS. 14 to 17 includes in addition to the motor vehicle 30 an interchangeable built-in unit 10, 20 with a base plate 10 and a foldable undercarriage 20, as already described with reference to FIGS. 6 to 9.

In the arrangement according to FIGS. 18 to 21, a recreational vehicle (RV) unit is installed on the base plate 10 of the arrangement depicted in FIGS. 14 to 17. The furniture items 50 of the recreational vehicle (RV) unit mounted on the base plate 10 are moved to the center of the base plate 10. After installation, and after the second and the third part 12, 13 are folded down, the furniture items can be moved to the outside, where they can be affixed.

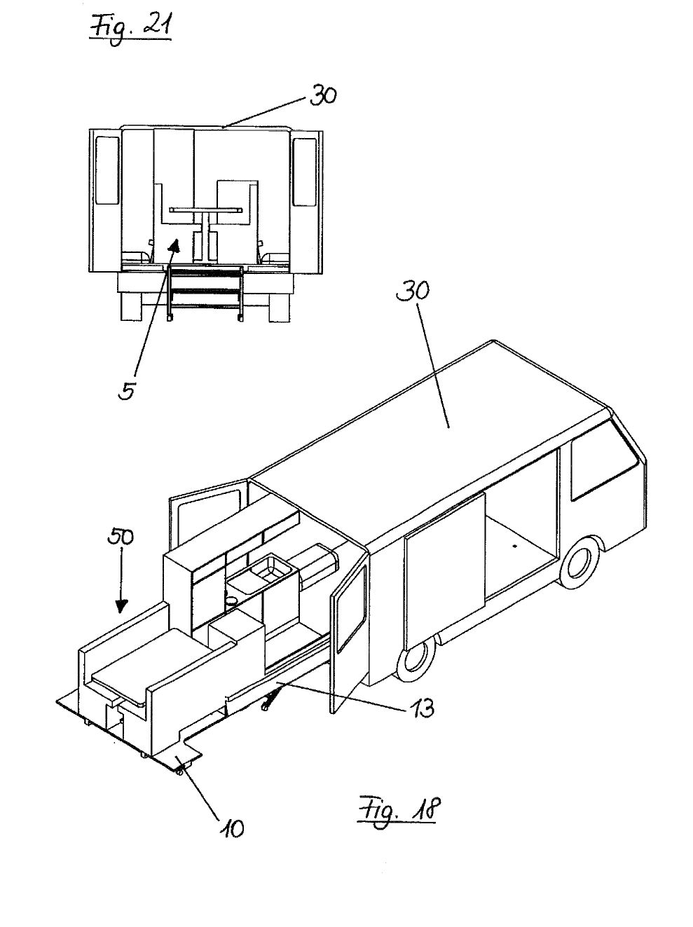

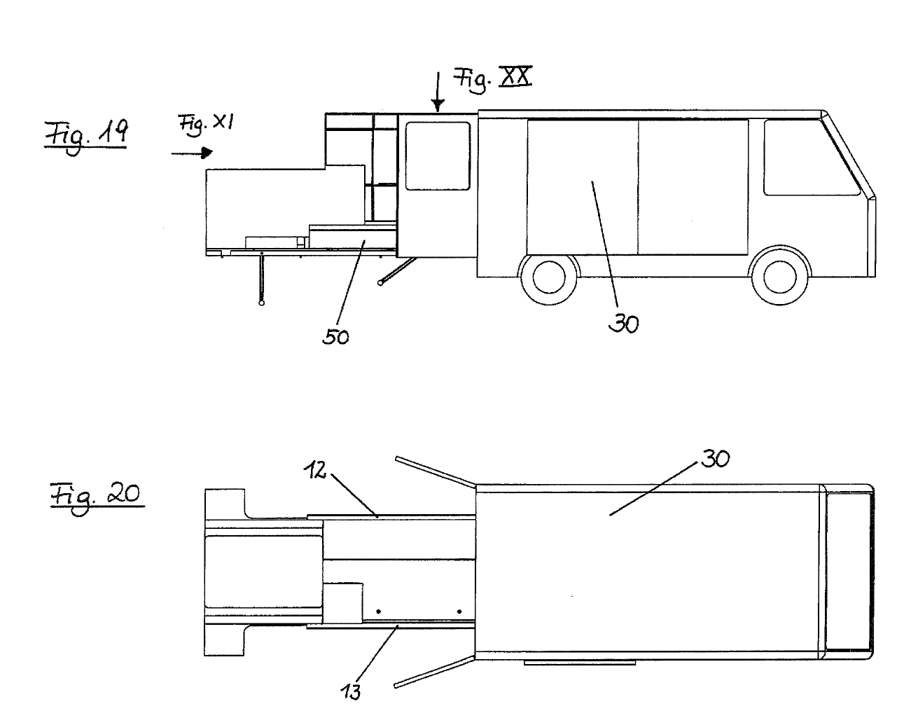

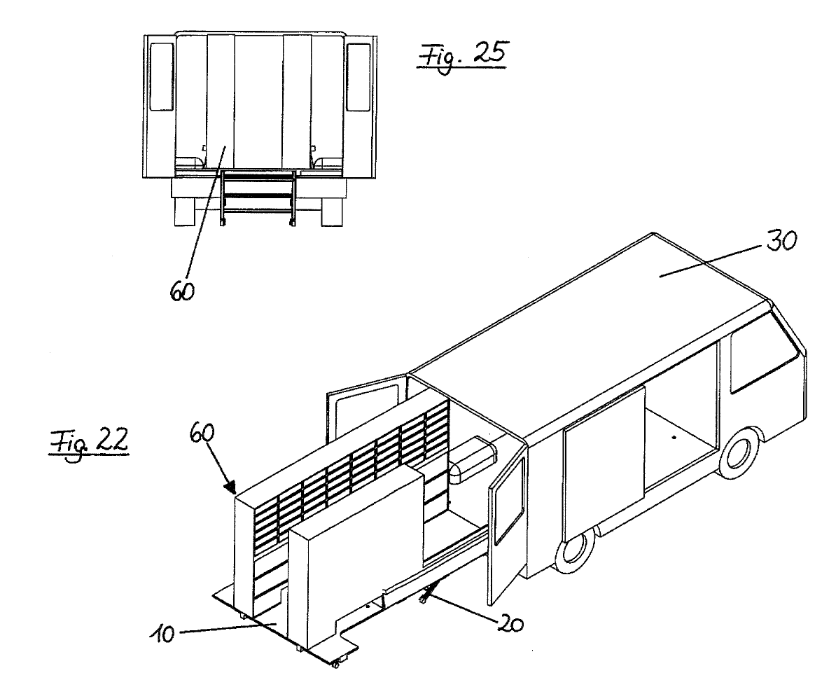

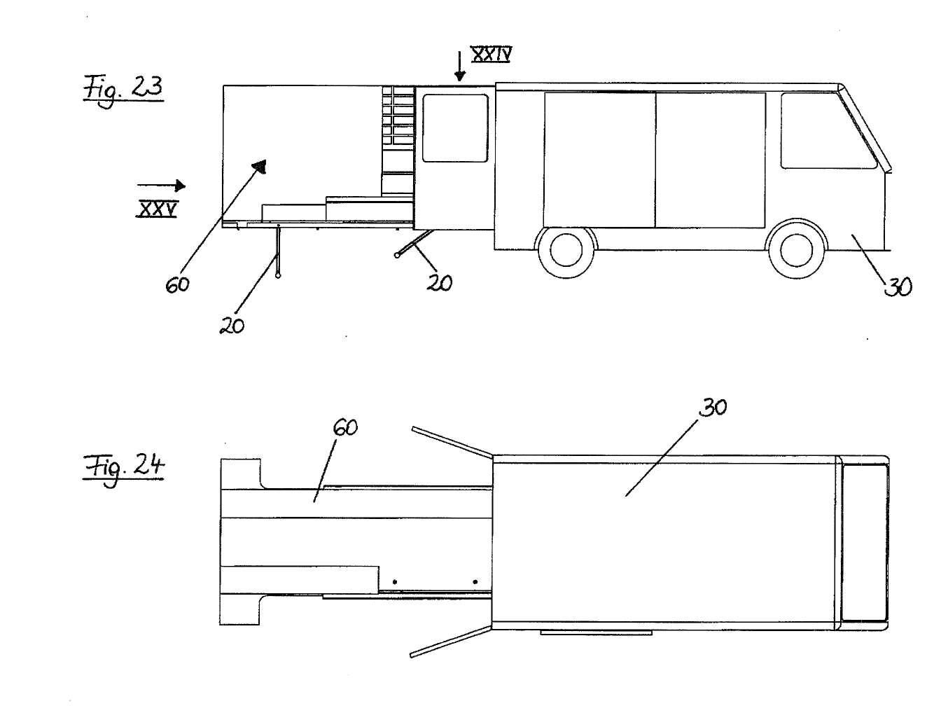

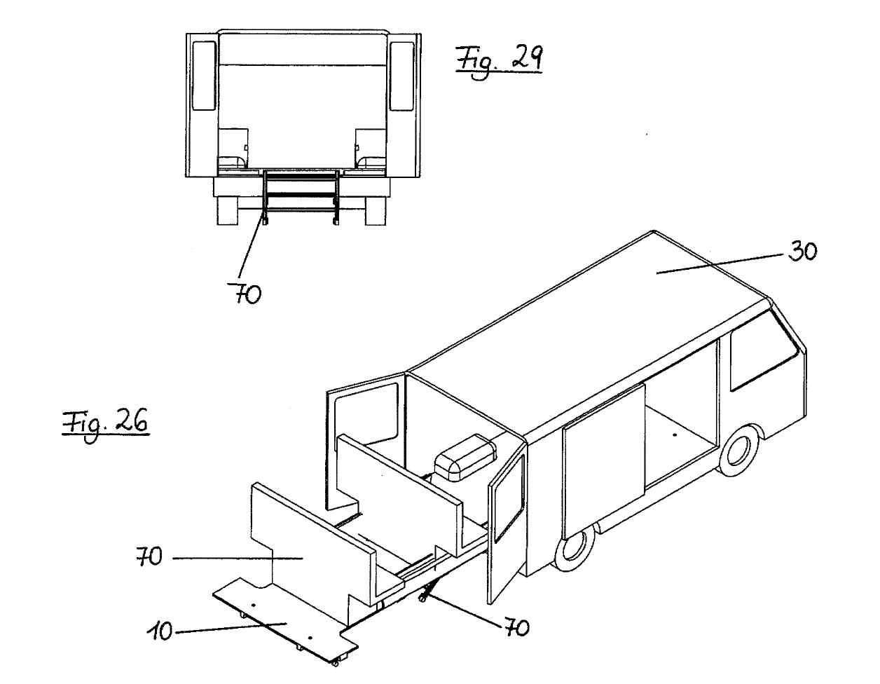

Conversely, in the arrangement according to FIGS. 22 to 25, shelves of a shelving system or cabinet system are mounted on the base plate 10. An arrangement consisting of the vehicle 30 and the interchangeable built-in unit 10, 20, 60 can be used, for example, as a vehicle for an installation business.

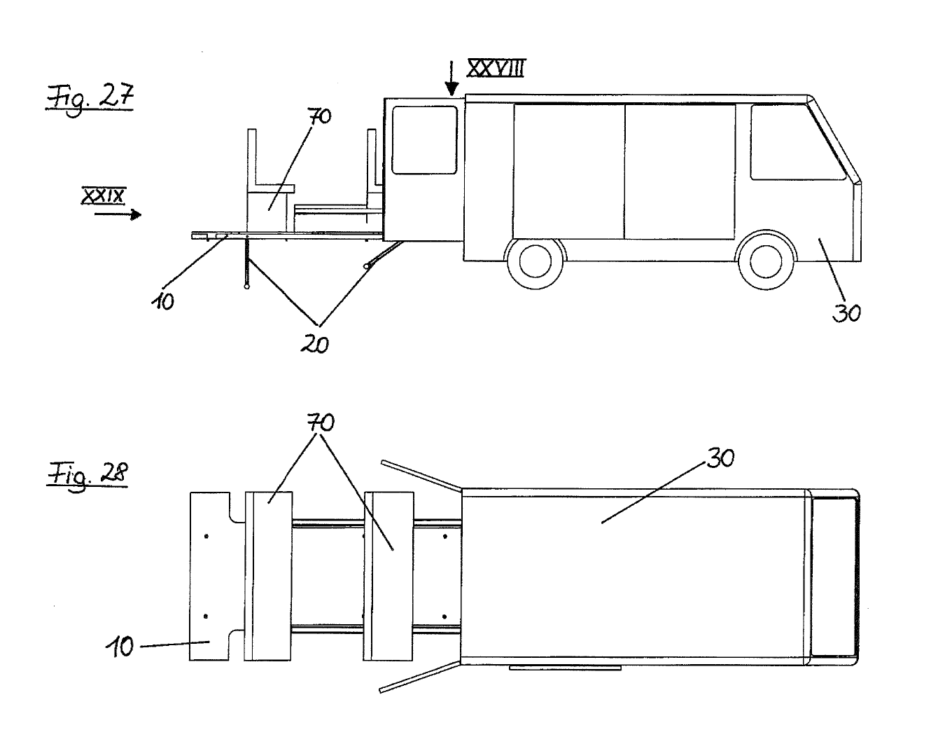

In the arrangement according to FIGS. 26 to 29, benches 70 are mounted on the base plate 10. The vehicle 30 with the interchangeable built-in unit 10, 20, 70 can be used as minibus for transporting passengers.

1. An interchangeable built-in unit for vehicle upper bodies, comprising:
a base plate configured for installation and removal on a floor of an upper body of a vehicle,
the base plate includes fastening means (16) for attaching the base plate to floor.

2. The interchangeable built-in unit according to claim 1, wherein the interchangeable built-in unit comprises furniture items attached on the base plate.

3. The interchangeable built-in unit according to claim 2, wherein the furniture items are releasably attached on the base plate.

4. The interchangeable built-in unit according to claim 2, wherein the attachment location of the furniture items on the base plate is changeable.

5. The interchangeable built-in unit according to claim 4, wherein the furniture items are movable and/or rotatable on the base plate.

6. The interchangeable built-in unit according to claim 2, wherein the furniture items comprise benches, individual seats, shelves, cabinets and/or tables.

7. The interchangeable built-in unit according to claim 1, wherein the base plate comprises a bottom side and wherein at least one of rollers, rails and sliders is mounted on the bottom side of the base plate to facilitate the movability on the floor of the vehicle.

8. The interchangeable built-in unit according to claim 1, comprising a foldable or collapsible undercarriage disposed on the bottom side of the base plate for accepting the interchangeable built-in unit when moved outside the vehicle body.

9. The interchangeable built-in unit according to claim 1, wherein the interchangeable built-in unit comprises eyelets, hooks and the like, to which a lifting gear can be attached.

10. The interchangeable built-in unit according to claim 1, wherein the bottom side of the base plate has regions configured for engagement with a lifting fork of a lifting van or a forklift.

11. The interchangeable built-in unit according to claim 1, wherein the base plate comprises a first, a second and a third part, each is connected by hinges to the base plate.

12. An arrangement of a vehicle and an interchangeable built-in unit which is at least indirectly removably mounted on a floor of an interior space of the vehicle, wherein the interchangeable built-in unit comprising:
a base plate configured for installation and removal on a floor of an upper body of a vehicle,
the base plate includes fastening means (16) for attaching the base plate to floor.

13. The arrangement according to claim 12, comprising a connecting plate, on which the interchangeable built-in unit is removably mounted, is installed on the floor of the interior space by fastening means.

14. The arrangement according to claim 12, comprising
a connecting plate, on which the interchangeable built-in unit is removably mounted, is installed on the base plate by space by fastening means,
wherein the fastening means or the base plate of the interchangeable built-in unit is removably mounted and are provided on the floor of vehicle.

15. The arrangement according to claim 12, further comprising rollers, rails or sliders, on which the base plate is movable, said rollers, rails or sliders are arranged on the floor of the vehicle or on the connecting plate.

16. The arrangement according to one of claims 12, wherein the vehicle has a rear door through which the disassembled interchangeable built-in unit is removed.

17. The interchangeable built-in unit according to claim 1, wherein the vehicle is one of a station wagon, delivery van, minibus, trailer with enclosed upper bodies.
